(19) United States
(12) Patent Application Publication
(10) Pub. No.: US 2023/0032357 A1
(43) Pub. Date: Feb. 2, 2023

(54) SYSTEM AND METHOD FOR CALLING ATTENTION

(71) Applicant: NEC Corporation, Minato-ku, Tokyo (JP)

(72) Inventor: Masatoshi Fukukawa, Tokyo (JP)

(73) Assignee: NEC Corporation, Minato-ku, Tokyo (JP)

(21) Appl. No.: 17/791,629

(22) PCT Filed: Jan. 23, 2020
(86) PCT No.: PCT/JP2020/002221

§ 371 Date: Jul. 8, 2022

(51) Int. Cl. G08B 25/01; G08B 25/14; G08B 21/02; G08B 17/00; G08B 5/22; A42B 3/04

(52) U.S. Cl. CPC G08B 25/016; A42B 3/046; G08B 5/225; G08B 17/00; G08B 21/02; G08B 25/14

(57) ABSTRACT

A system for calling attention according to the present disclosure includes: at least one sensor configured to detect environmental information; a storage device in which condition data representing a condition under which a specific incident occurs is stored; determination means for determining a possibility of an occurrence of the specific incident based on a result of the detection by the sensor and the condition data stored in the storage device; and calling attention means for calling attention to a fact that there is the possibility of the occurrence of the specific incident, in which when the determination means determines that there is the possibility of the occurrence of the specific incident, the calling attention means calls attention to the fact that there is the possibility of the occurrence of the specific incident.

### TECHNICAL FIELD

The present disclosure relates to a system and method for calling attention.

### BACKGROUND ART

For example, Patent Literature 1 discloses an apparatus that simulates a flashover or a backdraft for enabling members of a fire brigade to be trained to respond thereto.

### Citation List

### Patent Literature

Patent Literature 1: Published Japanese Translation of PCT International Publication for Patent Application, No. 2003-516207

### SUMMARY OF INVENTION

### Technical Problem

However, although a flashover and a backdraft can be simulated in the system disclosed in Patent Literature 1, it does not propose at all to call attention to the fact that there is a possibility of an occurrence of sudden combustion such as a flashover and a backdraft in an environment in which members of a fire brigade are working.

In view of the above-described problem, an object of the present disclosure is to provide a system and method for calling attention capable of calling attention to the fact that there is a possibility of an occurrence of a specific incident (e.g., sudden combustion such as a flashover and a backdraft in an environment in which members of a fire brigade are working).

### Solution to Problem

A system for calling attention according to a first aspect of the present disclosure includes: at least one sensor configured to detect environmental information; a storage device in which condition data representing a condition under which a specific incident occurs is stored; determination means for determining a possibility of an occurrence of the specific incident based on a result of the detection by the sensor and the condition data stored in the storage device; and calling attention means for calling attention to a fact that there is the possibility of the occurrence of the specific incident, in which when the determination means determines that there is the possibility of the occurrence of the specific incident, the calling attention means calls attention to the fact that there is the possibility of the occurrence of the specific incident.

A method for calling attention according to a second aspect of the present disclosure includes: a step of detecting, by at least one sensor configured to detect environmental information, the environmental information; a step of determining a probability of an occurrence of a specific incident based on a result of the detection by the sensor and condition data representing a condition under which the specific incident occurs, the condition data being stored in a storage device; and a step of, when it is determined that there is the probability of the occurrence of the specific incident in the determining step, calling attention to a fact that there is the possibility of the occurrence of the specific incident.

### Advantageous Effects of Invention

According to the present invention, it is possible to provide a system and method for calling attention capable of calling attention to the fact that there is a possibility of an occurrence of a specific incident (e.g., sudden combustion such as a flashover and a backdraft in an environment in which members of a fire brigade work).

### BRIEF DESCRIPTION OF DRAWINGS

FIG. 1 is a schematic configuration diagram of a system 1 for calling attention;

FIG. 2 is a detailed configuration diagram of the system 1 for calling attention;

FIG. 3 shows an example of a picture G1 (a virtual image) displayed on a head-up display 10a;

FIG. 4 shows an example of a picture G2 displayed on a display 23;

FIG. 5 is a sequence diagram of operations performed by the system 1 for calling attention (an alert process 1);

FIG. 6 is a sequence diagram of operations performed by the system 1 for calling attention (an alert process 2); and

FIG. 7 is a sequence diagram of operations (a learning process) performed by the system 1 for calling attention.

### EXAMPLE EMBODIMENT

### First Example Embodiment

A system 1 for calling attention according to a first example embodiment of the present invention will be described hereinafter with reference to the attached drawings. The same reference numerals (symbols) are assigned to corresponding components throughout the drawings, and redundant descriptions thereof are omitted.

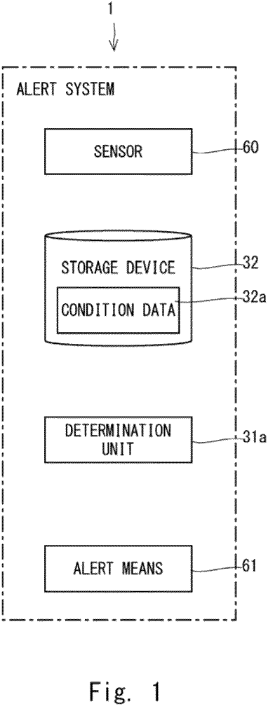

Firstly, the configuration of the system 1 for calling attention will be described with reference to FIG. 1.

FIG. 1 is a schematic configuration diagram of the system 1 for calling attention.

As shown in FIG. 1, the system 1 for calling attention includes at least one sensor 60 that detects environmental information, a storage device 32 in which condition data 32a representing conditions under which a specific incident occurs is stored, determination means 31a for determining a possibility of an occurrence of the specific incident based on the result of the detection by the sensor 60 and the condition data 32a stored in the storage device 32, and calling attention means 61 for calling attention to the fact that there is the possibility of the occurrence of the specific incident. When the determination means 31a determines that there is the possibility of the occurrence of the specific incident, the calling attention means 61 calls attention to the fact that there is the possibility of the occurrence of the specific incident.

According to the first example embodiment, it is possible to immediately call attention to the fact that there is a possibility of an occurrence of a specific incident (e.g., sudden combustion such as a flashover and a backdraft in an environment in which members of a fire brigade work).

### Second Example Embodiment

As a second example embodiment of the present invention, the system 1 for calling attention will be described hereinafter in a more detailed manner. An example in which the specific incident is sudden combustion (e.g., a flashover or a backdraft) that may occur in an environment in which members of a fire brigade work (i.e., are working) will be described hereinafter.

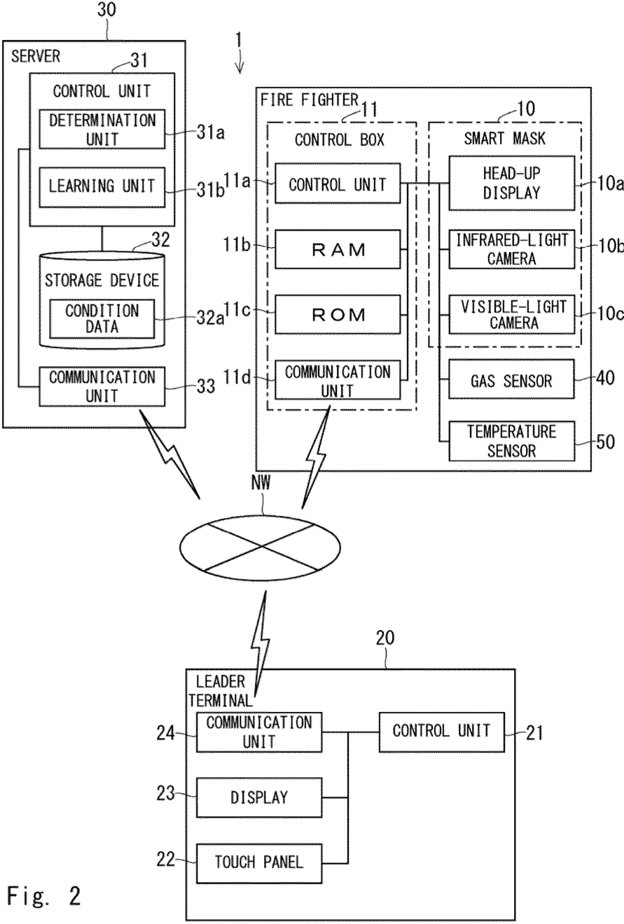

FIG. 2 is a detailed configuration diagram of the system 1 for calling attention.

As shown in FIG. 2, in the second example embodiment, an infrared-light camera 10b, a visible-light camera 10c, a gas sensor(s) 40, and a temperature sensor 50 are used as the sensors 60. Further, a head-up display 10a is used as the calling attention means 61.

As shown in FIG. 2, the system 1 for calling attention includes a smart mask 10, a control BOX 11, the gas sensor(s) 40, the temperature sensor 50, a captain terminal 20, and a server 30.

Firstly, the configuration of the smart mask 10 will be described.

The smart mask 10 includes a mask (not shown) worn by a member of a fire brigade who works at a fire site, the head-up display 10a, the infrared-light camera 10b, and the visible-light camera 10c.

The head-up display 10a, the infrared-light camera 10b, and the visible-light camera 10c are attached to the mask.

The head-up display 10a is transparent, and various pictures (virtual images) are displayed in a superimposed manner with the actual field of view of the member of the fire brigade wearing the smart mask 10 (the mask).

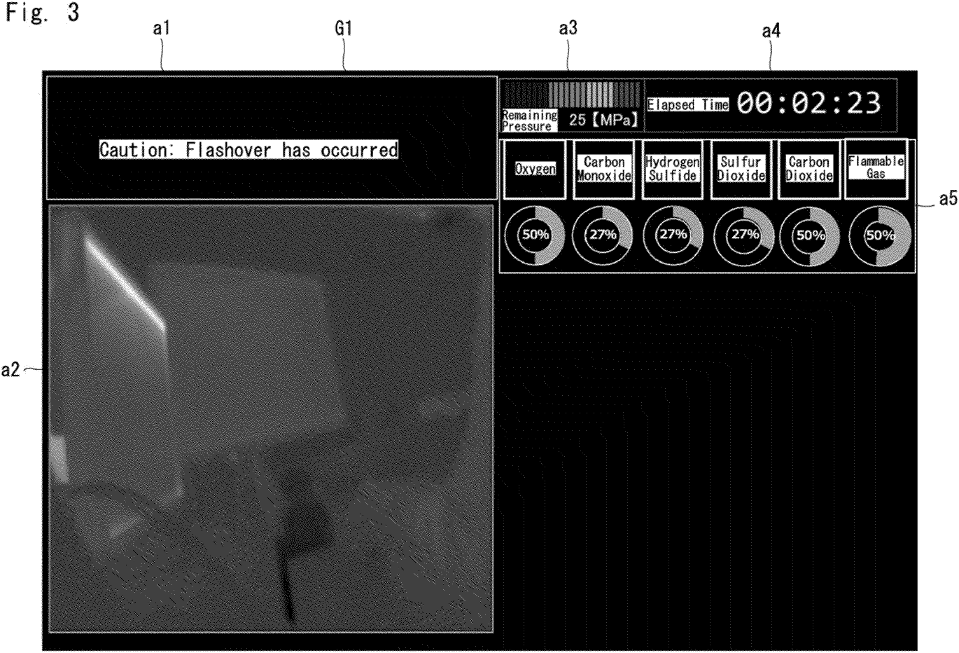

FIG. 3 shows an example of a picture G1 (e.g., a window G1) (a virtual image) displayed on the head-up display 10a.

As shown in FIG. 3, the picture G1 includes a remote support message display area a1, a camera image display area a2, an air cylinder remaining amount (remaining pressure) display area a3, an entry elapsed time display area a4, and a detection target gas concentration display area a5.

In the remote support message display area a1, various messages transmitted from the captain terminal 20 or the server 30 are displayed. For example, in the remote support message display area a1, information indicating that there is a possibility of an occurrence of sudden combustion in an environment in which the member of the fire brigade works (e.g., “Caution: Flashover has occurred”) is displayed. The head-up display 10a is an example of the calling attention means of the present invention. The sudden combustion that may occur in the environment in which a member(s) of a fire brigade works is, for example, a flashover or a backdraft.

In the camera image display area a2, images (moving images or still images) taken by the infrared-light camera 10b or the visible-light camera 10c are displayed.

In the air cylinder remaining amount (remaining pressure) display area a3, the remaining amount (the remaining pressure) of an air cylinder equipped by the member of the fire brigade is displayed.

In the entry elapsed time display area a4, the time that has elapsed after the member(s) of the fire brigade entered the fire site is displayed.

In the detection target gas concentration display area a5, the concentrations of various gases, which are the results of the detection by the gas sensor(s) 40, are displayed.

The infrared-light camera 10b is an image-pickup apparatus that photographs (or films) the environment in which a member of a fire brigade works, and is used when, for example, the environment in which the member of the fire brigade works is dark. The visible-light camera 10c is an image-pickup apparatus that photographs (or films) the environment in which the member of the fire brigade works, and is used when, for example, the environment in which the member of the fire brigade works is bright.

The gas sensor(s) 40 and the temperature sensor 50 are attached to the outfit (e.g., a fire suit) worn by the member of the fire brigade.

The gas sensor(s) 40 detects the concentration(s) of a gas(es) in the environment in which the member of the fire brigade works. The gas sensor 40 is, for example, an oxygen sensor for detecting the concentration of oxygen, a carbon monoxide sensor for detecting the concentration of carbon monoxide, a hydrogen sulfide sensor for detecting the concentration of hydrogen sulfide, a sulfur dioxide sensor for detecting the concentration of sulfur dioxide, and/or a flammable gas sensor for detecting the concentration of a flammable gas(es).

The temperature sensor 50 detects the temperature in the environment in which the member of the fire brigade works.

The infrared-light camera 10b, the visible-light camera 10c, the gas sensor 40, and the temperature sensor 50 are examples of the sensor(s) according to the present invention.

Next, the configuration of the control BOX 11 will be described.

The control BOX 11 includes a control unit 11a, a RAM (Random Access Memory) 11b, a ROM (Read Only Memory) 11c, and a communication unit 11d.

The control unit 11a includes a processor (not shown). The processor is, for example, a CPU (Central Processing Unit). The control unit 11a may include only one processor or may include a plurality of processors. The processor controls the smart mask 10 and the like by executing a certain program loaded from a nonvolatile memory such as the ROM 11c into the RAM 11b.

The communication unit 11d is a communication apparatus that wirelessly communicates with the captain terminal 20 and the server 30 through a communication line NW (e.g., the Internet).

Next, the configuration of the captain terminal 20 will be described.

The captain terminal 20 is, for example, a tablet-type information processing terminal, and as shown in FIG. 2, includes a control unit 21, a touch panel 22, a display 23, and a communication unit 24.

The control unit 21 includes a processor (not shown). The processor is, for example, a CPU. The control unit 21 may include only one processor or may include a plurality of processors. The processor controls the display 23 and the like by executing a certain program loaded from a nonvolatile memory such as a ROM (not shown) into a RAM (not shown).

The touch panel 22 is an input device operated by the captain of the fire brigade, and is disposed so as to cover the display surface of the display 23. The display 23 is, for example, a display equipped with the touch panel 22. A display equipped with a touch panel is also called a touch screen display.

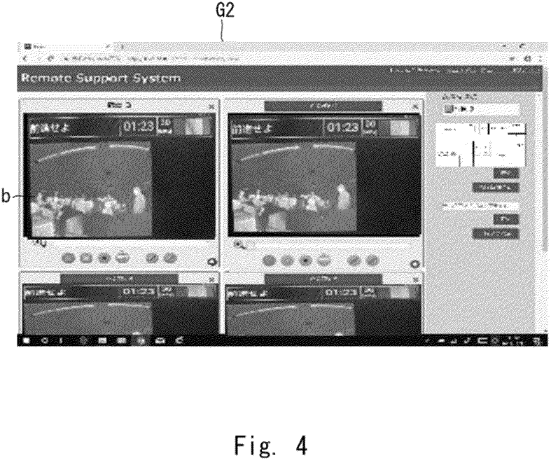

FIG. 4 shows an example of a picture G2 displayed on the display 23.

As shown in FIG. 4, the picture G2 includes a camera image display area b.

In the camera image display area b, the same images (the same moving images or the same still images) as those displayed on the head-up display 10a of the smart mask 10 worn by the member of the fire brigade are displayed.

The communication unit 24 is a communication apparatus that wirelessly communicates with the control BOX 11 and the server 30 through the communication line NW (e.g., the Internet).

Next, the configuration of the server 30 will be described.

The server 30 is installed at a place remote from the fire site. As shown in FIG. 2, the server 30 includes a control unit 31, a storage device 32, and a communication unit 33.

The control unit 31 includes a processor (not shown). The processor is, for example, a CPU. The control unit 31 may include only one processor or may include a plurality of processors. The processor functions as a determination unit 31a and a learning unit 31b by executing a certain program loaded from a nonvolatile memory such as a ROM (not shown) into a RAM (not shown).

The determination unit 31a determines (predicts) a possibility of an occurrence of sudden combustion in the environment in which the member of the fire brigade works based on the results of the detection by the various sensors, received from the control BOX 11 and the condition data 32a stored in the storage device 32. The determination unit 31a is an example of the determination means of the present invention.

The learning unit 31b learns conditions under which sudden combustion occurs based on the detection results of the various sensors, received from the control BOX 11. The learning unit 31b is an example of the learning means of the present invention. In some cases, the learning unit 31b learns conditions under which sudden combustion occurs based on past cases or the like in which sudden combustion occurred.

In the storage device 32, the condition data 32a representing conditions (one condition or a plurality of conditions) under which sudden combustion occurs. The conditions under which the sudden combustion occurs are, for example, a numerical value(s) or a numerical value range(s) representing the concentration(s) of a gas(es) at which sudden combustion occurs. This numerical value or the numerical value range may be calculated, for example, based on experiments or past cases.

Further, the conditions under which sudden combustion occurs are, for example, data representing characteristics of flames shown in images (e.g., moving images) taken by the image-pickup apparatus. The data representing the characteristics of flames are, for example, data representing the movements, colors, sizes, and/or the like of the flames. The data representing the characteristics of flames can be calculated, for example, by performing image processing on images taken in experiments or past cases.

The communication unit 33 is a communication apparatus that wirelessly communicates with the control BOX 11 and the captain terminal 20 through the communication line NW (e.g., the Internet).

Next, an alert process 1 will be described as an example of operations performed by the system 1 for calling attention having the above-described configuration.

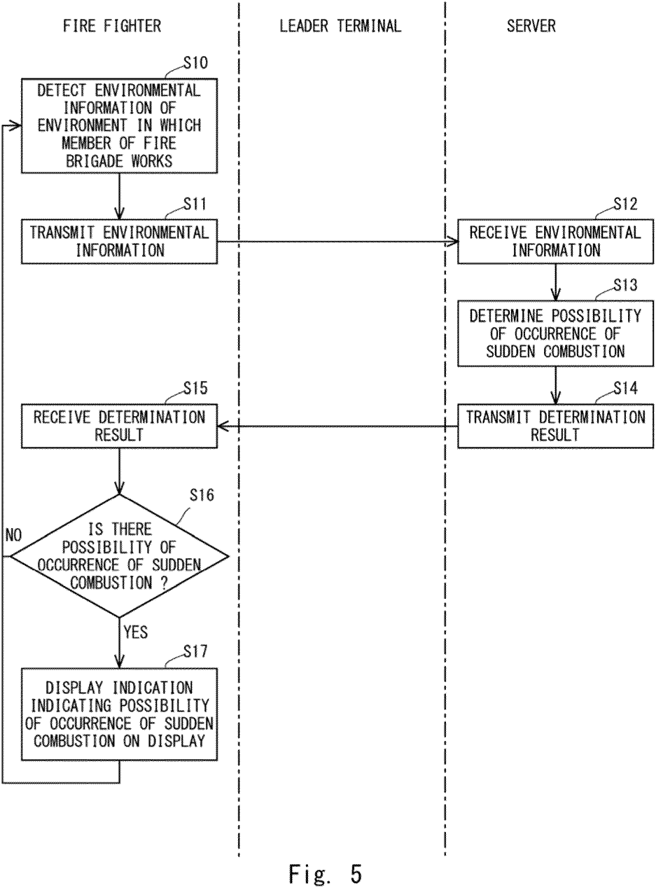

FIG. 5 is a sequence diagram of operations performed by the system 1 for calling attention (the alert process 1).

In the following description, it is assumed that the picture G1 shown in FIG. 2 has been displayed on the head-up display 10a worn by the member of the fire brigade.

Firstly, various sensors detect environmental information of the environment in which the member of the fire brigade works (Step S10). For example, the infrared-light camera 10b photographs (or films) the environment in which the member of the fire brigade works. Further, the gas sensor 40 detects the concentration(s) of a gas(es) in the environment in which the member of the fire brigade works. Further, the temperature sensor 50 detects the temperature in the environment in which the member of the fire brigade works.

Next, the control BOX 11 (the communication unit 11d) transmits the environmental information (the results of the detection by the various sensors) detected in the step S10 to the server 30 through the communication line NW (Step S11).

Next, the server 30 (the communication unit 33) receives the environmental information transmitted from the control BOX 11 (Step S12).

Next, the server 30 (the determination unit 31a) determines (predicts) a possibility of an occurrence of sudden combustion in the environment in which the member of the fire brigade works based on the environmental information (the results of the detection by the various sensors) received from the control BOX 11 and the condition data 32a representing the conditions under which sudden combustion occurs, stored in the storage device 32 (Step S13).

For example, in the case where the environmental information (the results of the detection by the various sensors) received from the control BOX 11 is the result of the detection by the gas sensor 40 (and the result of the detection by the temperature sensor 50), the server 30 (the determination unit 31a) determines that there is a possibility of an occurrence of sudden combustion in the environment in which the member of the fire brigade works when the result of the detection by the gas sensor 40 (and the result of the detection by the temperature sensor 50) coincides with (or are similar to) the condition(s) under which sudden combustion occurs, i.e., the condition(s) represented by the condition data 32a stored in the storage device 32. In the other cases, the server 30 (the determination unit 31a) determines that there is no possibility of an occurrence of sudden combustion in the environment in which the member of the fire brigade works.

Meanwhile, in the case where the environmental information (the results of the detection by the various sensors) received from the control BOX 11 are images taken by the infrared-light camera 10b (or images taken by the visible-light camera 10c), the server 30 extracts data representing characteristics of flames shown in the images by performing image processing on the images. Then, when the extracted data representing the characteristics of the flames coincides with (or is similar to) the conditions under which sudden combustion occurs, i.e., the conditions represented by the condition data 32a stored in the storage device 32, the server 30 (the determination unit 31a) determines that there is a possibility of an occurrence of sudden combustion in the environment in which the member of the fire brigade works. In the other cases, the server 30 (the determination unit 31a) determines that there is no possibility of an occurrence of sudden combustion in the environment in which the member of the fire brigade works.

Next, the server 30 (the communication unit 33) transmits the result of the determination made in the step S13 to the control BOX 11 through the communication line NW (Step S14).

Next, the control BOX 11 (the communication unit 11d) receives the determination result transmitted from the server 30 (Step S15).

Then, when the determination result received from the server 30 indicates that there is a possibility of an occurrence of sudden combustion (Step S16: Yes), the control BOX 11 (the control unit 11a) controls the head-up display 10a so as to display, in the remote support message display area a1 of the picture G1, information indicating that there is a possibility of an occurrence of sudden combustion in the environment in which the member of the fire brigade works (e.g., “Caution: Flashover has occurred”) (Step S17).

In this way, it is possible to directly and immediately call attention the members of the fire brigade to the fact that there is a possibility of an occurrence of sudden combustion in the environment in which they work.

Next, an alert process 2 will be described as an example of operations performed by the system 1 for calling attention having the above-described configuration.

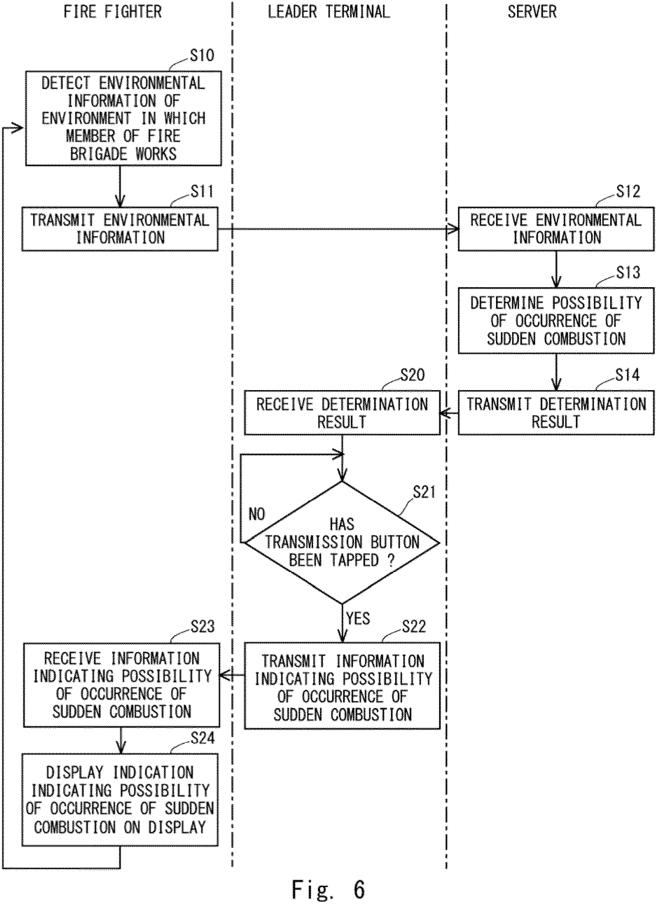

FIG. 6 is a sequence diagram of operations performed by the system 1 for calling attention (the alert process 2).

The flowchart shown in FIG. 6 is equivalent to one that is obtained by removing the steps S15 to S17 in the flowchart shown in FIG. 5 and adding processes in steps S20 to S24 therein. Differences from FIG. 5 will be mainly described hereinafter.

In the following description, it is assumed that the picture G1 shown in FIG. 2 has been displayed on the head-up display 10a worn by the member of the fire brigade.

The captain terminal 20 (the communication unit 24) receives the determination result transmitted from the server 30 (Step S20). Next, the captain terminal 20 (the control unit 21) controls the display 23 so as to display the determination result, for example, information indicating that there is a possibility of an occurrence of sudden combustion in the environment in which the members of the fire brigade work (e.g., “Caution: Flashover has occurred”) in the picture G2.

Then, when the captain of the fire brigade who has seen the above-described display, for example, taps a transmission button (not shown) displayed on the display 23 through the touch panel 22 (Step S21: Yes), the captain terminal 20 (the communication unit 24) transmits information indicating that there is a possibility of an occurrence of sudden combustion in the environment in which the members of the fire brigade work to the control BOX 11 through the communication line NW (Step S22).

Next, the control BOX 11 (the communication unit 11d) receives the information indicating that there is a possibility of an occurrence of sudden combustion in the environment in which the member of the fire brigade works, transmitted from the captain terminal 20 (Step S23).

Then, the control BOX 11 (the control unit 11a) controls the head-up display 10a so as to display, in the remote support message display area a1 of the picture G1, the information indicating that there is a possibility of an occurrence of sudden combustion in the environment in which the member of the fire brigade works (e.g., “Caution: Flashover has occurred”) (Step S24)

In this way, it is possible to directly and immediately call attention the captain of the fire brigade and the members of the fire brigade to the fact that there is a possibility of an occurrence of sudden combustion in the environment in which they work.

Next, as an example of operations performed by the system 1 for calling attention having the above-described configuration, a learning process for learning conditions under which sudden combustion occurs will be described.

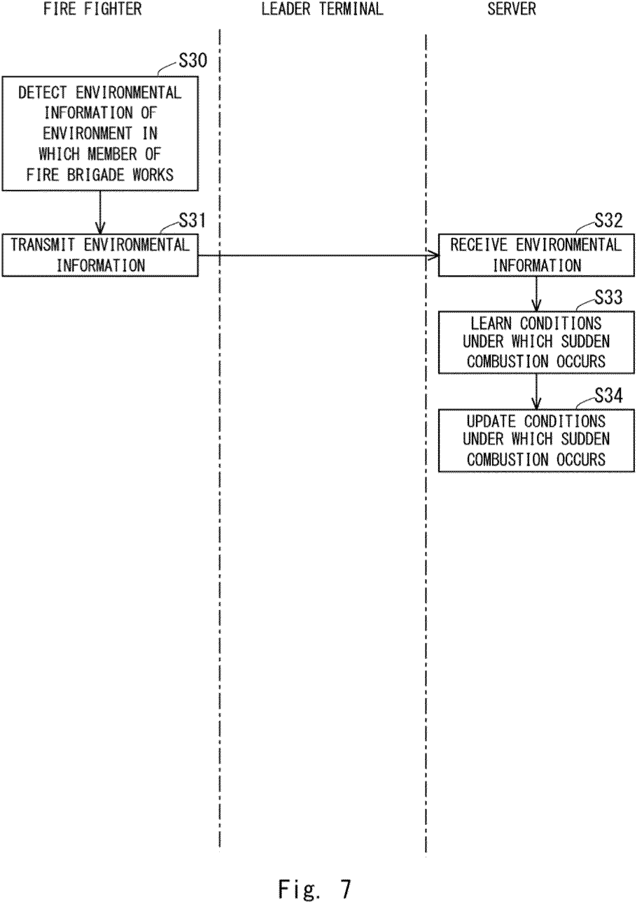

FIG. 7 is a sequence diagram of operations (a learning process) performed by the system 1 for calling attention.

Firstly, various sensors detect environmental information of the environment in which members of a fire brigade work (Step S30). For example, the infrared-light camera 10b photographs (or films) the environment in which the member of the fire brigade works. Further, the gas sensor 40 detects the concentration(s) of a gas(es) in the environment in which the member of the fire brigade works. Further, the temperature sensor 50 detects the temperature in the environment in which the member of the fire brigade works.

Next, the control BOX 11 (the communication unit 11d) transmits the environmental information (the results of the detection by the various sensors) detected in the step S30 to the server 30 through the communication line NW (Step S31).

Next, the server 30 (the communication unit 33) receives the environmental information transmitted from the control BOX 11 (Step S32).

Next, the server 30 (the learning unit 31b) learns conditions under which sudden combustion occurs based on the environmental information (the results of the detection by the various sensors) received from the control BOX 11 (Step S33).

Then, based on the result of the learning by the learning unit 31b, the server 30 successively updates the condition data 32a representing the conditions under which sudden combustion occurs, stored in the storage device 32 (Step S34).

As described above, according to the second example embodiment, it is possible to directly and immediately call attention (working) members of a fire brigade and the like who work at a fire site to the fact that there is a possibility of an occurrence of sudden combustion such as a flashover and a backdraft in an environment in which they work.

Next, modified examples will be described.

In the above-described second example embodiment (the alert process 1), the server 30 (the communication unit 33) transmits the result of the determination made in the step S13 to the control BOX 11 through the communication line NW, and when the determination result received from the server 30 indicates that there is a possibility of an occurrence of sudden combustion (Step S16: Yes), the control BOX 11 (the control unit 11a) controls the head-up display 10a so as to display, in the remote support message display area a1 of the picture G1, information indicating that there is a possibility of an occurrence of sudden combustion in the environment in which members of a fire brigade work (e.g., “Caution: Flashover has occurred”) (Step S17). However, the procedure according to present invention is not limited to the above-described procedure.

For example, when the server 30 (the communication unit 33) transmits the result of the determination made in the step S13 to the captain terminal 20 through the communication line NW, and the determination result received from the server 30 indicates that there is a possibility of an occurrence of sudden combustion, the captain terminal 20 (the control unit 21) may control the display 23 so as to display information indicating that there is a possibility of an occurrence of sudden combustion in the environment in which the member of the fire brigade works (e.g., “Caution: Flashover has occurred”).

Further, although an example in which the determination unit 31a, the learning unit 31b, and the storage device 32 are provided in the server 30 has been described in the above-described second example embodiment, the configuration according to the present invention is not limited to this example. For example, at least one or all of the determination unit 31a, the learning unit 31b, and the storage device 32 may be provided in the control BOX 11, in the captain terminal 20, or in other information processing terminals (not shown). When the determination unit 31a is provided in the control BOX 11, for example, the configuration of the so-called edge computing system can be adopted.

Further, although an example in which the infrared-light camera 10b, the visible-light camera 10c, the gas sensor 40, and the temperature sensor 50 are used as the sensors 60 has been described in the above-described second example embodiment, the configuration according to the present invention is not limited to this example. For example, at least one of the infrared-light camera 10b, the visible-light camera 10c, the gas sensor 40, and the temperature sensor 50 may not be provided, and/or other types of sensors may be added.

Further, although an example in which an oxygen sensor, a carbon monoxide sensor, a hydrogen sulfide sensor, a sulfur dioxide sensor, and a flammable gas sensor are used as the gas sensors 40 has been described in the above-described second example embodiment, the configuration according to the present invention is not limited to this example. For example, at least one of the oxygen sensor, the carbon monoxide sensor, the hydrogen sulfide sensor, the sulfur dioxide sensor, and the flammable gas sensor may not be provided, and/or other types of sensors may be added.

Further, although an example in which the head-up display 10a is used as the calling attention means 61 has been described in the above-described second example embodiment, the configuration according to the present invention is not limited to this example. For example, as the calling attention means 61, a speaker that outputs a sound or a voice representing information indicating that there is a possibility of an occurrence of sudden combustion in an environment in which members of a fire brigade work may be used, or a vibrator that vibrates when there is a possibility of an occurrence of sudden combustion in an environment in which members of a fire brigade work may be used.

Further, although an example in which the specific incident is sudden combustion (e.g., a flashover or a backdraft) that may occur in an environment in which members of a fire brigade work has been described in the above-described second example embodiment, the specific incident is not limited to this example. For example, the specific incident may be detection of sarin, anthrax, radiation, or the like. That is, the specific incident is an event for which it is generally considered, from the viewpoint of protecting human lives, desirable to call attention before it actually occurs, and it may be an event caused by a natural phenomenon (e.g., a flashover or a backdraft) or may be an artificially-caused event (e.g., spraying of sarin).

For example, the specific incident may be “an occurrence of a heat stroke.” In this case, it is possible to call attention, for example, as follows.

For example, a possibility of an occurrence of a heat stroke is determined by comparing biological information collected from a sensor(s) for detecting biological information (e.g., a blood pressure, an amount of sweating, and/or a body temperature) of a member of a fire brigade, attached to the member of the fire brigade with condition data representing conditions under which a heat stroke occurs (e.g., cases of heat stroke). Then, when it is determined that there is a possibility that a heat stroke may occur, the member of the fire brigade or the like is called attention to the fact that there is a possibility of an occurrence of a heat stroke as in the second example embodiment.

As described above, various events can be adopted as the specific incident. According to the first and second example embodiments, and the modified examples thereof, it is possible to call attention to the fact that there is a possibility of an occurrence of a specific incident before the specific incident actually occurs, and thereby to protect more human lives.

In the above-described first and second example embodiments, the program may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), CD-R, CD-R/W, and a semiconductor memory (such as a mask ROM, a PROM (Programmable ROM), an EPROM (Erasable PROM), a flash ROM, and a RAM (Random Access Memory)). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

All the numeral values mentioned in the above-described example embodiments are merely examples, and needless to say, numeral values different from them can be uses as desired.

The above-described example embodiments are merely examples in all the aspects thereof. The present invention should not be limited by the descriptions of the above-described example embodiments. The present invention may be carried out in various other forms without departing from the spirit or main features of the invention.

Further, the whole or part of the example embodiments disclosed above can be described as, but not limited to, the following supplementary notes.

### Supplementary Note 1

A system for calling attention comprising:
at least one sensor configured to detect environmental information;
a storage device in which condition data representing a condition under which a specific incident occurs is stored;
determination means for determining a possibility of an occurrence of the specific incident based on a result of the detection by the sensor and the condition data stored in the storage device; and
calling attention means for calling attention to a fact that there is the possibility of the occurrence of the specific incident, wherein
when the determination means determines that there is the possibility of the occurrence of the specific incident, the calling attention means calls attention to the fact that there is the possibility of the occurrence of the specific incident.

### Supplementary Note 2

The system for calling attention described in Supplementary note 1, wherein
the sensor is attached to an outfit worn by a member of a fire brigade and configured to detect environmental information of an environment in which a member of a fire brigade works, and
the specific incident is sudden combustion.

### Supplementary Note 3

The system for calling attention described in Supplementary note 2, wherein the sensor is at least one of a gas sensor, a temperature sensor, and image-pickup means.

### Supplementary Note 4

The system for calling attention described in Supplementary note 2 or 3, wherein the calling attention means is disposed in a mask worn by the member of the fire brigade.

### Supplementary Note 5

The system for calling attention described in Supplementary note 4, wherein the calling attention means is disposed in a captain terminal operated by a captain of a fire brigade.

### Supplementary Note 6

The system for calling attention described in Supplementary note 5, wherein when the captain of the fire brigade performs a predetermined operation on the captain terminal, the calling attention means disposed in the mask calls attention to the fact that there is the possibility of the occurrence of the specific incident.

### Supplementary Note 7

The system for calling attention described in any one of Supplementary notes 2 to 6, wherein the calling attention means is a display on which information indicating that there is the possibility of the occurrence of the specific incident is displayed.

### Supplementary Note 8

The system for calling attention described in Supplementary note 7, wherein the display is a head-up display provided in a mask worn by the member of the fire brigade.

### Supplementary Note 9

The system for calling attention described in any one of Supplementary notes 2 to 8, further comprising learning means for learning the condition under which the specific incident occurs based on a result of detection by the sensor, wherein the condition data stored in the storage device is updated based on a result of learning by the learning means.

### Supplementary Note 10

The system for calling attention described in any one of Supplementary notes 2 to 9, wherein the sudden combustion is a flashover or a backdraft.

### Supplementary Note 11

The system for calling attention described in any one of Supplementary notes 2 to 10, wherein the determination means is disposed in an outfit worn by the member of the fire brigade or in a server installed at a place remote from the environment.

### Supplementary Note 12

A method for calling attention comprising:
a step of detecting, by at least one sensor configured to detect environmental information, the environmental information;
a step of determining a probability of an occurrence of a specific incident based on a result of the detection by the sensor and condition data representing a condition under which the specific incident occurs, the condition data being stored in a storage device; and
a step of, when it is determined that there is the probability of the occurrence of the specific incident in the determining step, calling attention to a fact that there is the possibility of the occurrence of the specific incident.

### Supplementary Note 13

The method for calling attention described in Supplementary note 12, wherein
the sensor is attached to an outfit worn by a member of a fire brigade and configured to detect environmental information of an environment in which a member of a fire brigade works, and
the specific incident is sudden combustion.

### REFERENCE SIGNS LIST

1 ALERT SYSTEM
10 SMART MASK
10a HEAD-UP DISPLAY
10b INFRARED-LIGHT CAMERA
10c VISIBLE-LIGHT CAMERA
11 CONTROL BOX
11a CONTROL UNIT
11b RAM
11c ROM
11d COMMUNICATION UNIT
20 LEADER TERMINAL
21 CONTROL UNIT
22 TOUCH PANEL
23 DISPLAY
24 COMMUNICATION UNIT
30 SERVER
31 CONTROL UNIT
31a DETERMINATION UNIT
31b LEARNING UNIT
32 STORAGE DEVICE
32a CONDITION DATA
33 COMMUNICATION UNIT
40 GAS SENSOR
50 TEMPERATURE SENSOR
60 SENSOR
61 ALERT MEANS
G1 SCREEN
G2 SCREEN
a1 REMOTE SUPPORT MESSAGE DISPLAY AREA
a2 CAMERA IMAGE DISPLAY AREA
a3 DISPLAY AREA
a4 ENTRY ELAPSED TIME DISPLAY AREA
a5 DETECTION TARGET GAS CONCENTRATION DISPLAY AREA
NW COMMUNICATION LINE

What is claimed is:

1. A system for calling attention comprising:
at least one sensor configured to detect environmental information;
a storage device in which condition data representing a condition under which a specific incident occurs is stored;
determination means for determining a possibility of an occurrence of the specific incident based on a result of the detection by the sensor and the condition data stored in the storage device; and
calling attention means for calling attention to a fact that there is the possibility of the occurrence of the specific incident, wherein
when the determination means determines that there is the possibility of the occurrence of the specific incident, the calling attention means calls attention to the fact that there is the possibility of the occurrence of the specific incident.

2. The system for calling attention according to claim 1, wherein
the sensor is attached to an outfit worn by a member of a fire brigade and configured to detect environmental information of an environment in which a member of a fire brigade works, and
the specific incident is sudden combustion.

3. The system for calling attention according to claim 2, wherein the sensor is at least one of a gas sensor, a temperature sensor, and image-pickup means.

4. The system for calling attention according to claim 2, wherein the calling attention means is disposed in a mask worn by the member of the fire brigade.

5. The system for calling attention according to claim 4, wherein the calling attention means is disposed in a captain terminal operated by a captain of a fire brigade.

6. The system for calling attention according to claim 5, wherein when the captain of a fire brigade performs a predetermined operation on the captain terminal, the calling attention means disposed in the mask calls attention to the fact that there is the possibility of the occurrence of the specific incident.

7. The system for calling attention according to claim 2, wherein the calling attention means is a display on which information indicating that there is the possibility of the occurrence of the specific incident is displayed.

8. The system for calling attention according to claim 7, wherein the display is a head-up display provided in a mask worn by the member of the fire brigade.

9. The system for calling attention according to claim 2, further comprising learning means for learning the condition under which the specific incident occurs based on a result of detection by the sensor, wherein
the condition data stored in the storage device is updated based on a result of learning by the learning means.

10. The system for calling attention according to claim 2, wherein the sudden combustion is a flashover or a backdraft.

11. The system for calling attention according to claim 2, wherein the determination means is disposed in an outfit worn by the member of the fire brigade or in a server installed at a place remote from the environment.

12. A method for calling attention comprising:
a step of detecting, by at least one sensor configured to detect environmental information, the environmental information;
a step of determining a probability of an occurrence of a specific incident based on a result of the detection by the sensor and condition data representing a condition under which the specific incident occurs, the condition data being stored in a storage device; and
a step of, when it is determined that there is the probability of the occurrence of the specific incident in the determining step, calling attention to a fact that there is the possibility of the occurrence of the specific incident.

13. The method for calling attention according to claim 12, wherein
the sensor is attached to an outfit worn by a member of a fire brigade and configured to detect environmental information of an environment in which a member of a fire brigade works, and
the specific incident is sudden combustion.
